(19) United States
(12) Patent Application Publication
(10) Pub. No.: US 2012/0058657 A1
(43) Pub. Date: Mar. 8, 2012

(54) ELECTRICAL CARD CONNECTOR HAVING DETECTING CONTACTS ACTUATED BY SLIDER

(75) Inventor: LAI-ANG HU, Kunshan (CN)

(73) Assignee: HON HAI PRECISION INDUSTRY CO., LTD., New Taipei (TW)

(21) Appl. No.: 13/226,504

(22) Filed: Sep. 7, 2011

(30) Foreign Application Priority Data
Sep. 8, 2010 (CN) 201010277054.4

(51) Int. Cl. H01R 29/00

(52) U.S. Cl. 439/188

(57) ABSTRACT

An electrical card connector includes an insulative housing (1) and a switch (21) supported by the insulative housing. The switch (21) includes a first switch pin (22) and a second switch pin (23). The first switch pin (22) has a first contacting portion (223) and a reacting portion (224). The second switch portion (23) has a second contacting portion (233). A slider (60) is mounted adjacent to the switch (21). The slider (60) is configured with a recess (602) and a depressing portion (603). When the reacting portion (224) is located in the recess (602), the first contacting portion (223) separating from the second contacting portion (233). And when the depressing portion (603) depresses the reacting portion (224), the first contacting portion (223) is in contacting with the second contacting portion (233).

### BACKGROUND OF THE INVENTION

1. Field of the Invention

The present invention relates to an electrical card connector, and more particularly to an electrical card connector improved detecting mechanism configured by a switch and a slider actuating the switch for ensuring correct mating a card.

2. Description of Related Art

U.S. Pat. No. 6,126,464 issued to Chang on Oct. 3, 2000 discloses a card connector which includes an insulative housing, a plurality of contacts mounted to the housing and a metallic shell enclosing the housing. An receiving space is formed between the housing and the metallic shell. The housing has a plurality of contact grooves for securing the contacts therein. The contacts include a pair of switch pins located in an interior segment of the inserting space along a card inserting direction. When the card is inserted into and located on an unwanted position of the receiving space, the card may not in contact with the switch pins, then the card can not work with the card connector.

Hence, an improved electrical card connector is required to overcome the problems of the prior art.

### SUMMARY OF THE INVENTION

An object of the present invention is to provide an electrical card connector with improved switch contacts so as to ensure a correct mating a card.

Accordingly, to achieve above-mentioned object, an electrical card connector includes an insulative housing having a plurality of contact grooves, a plurality of signal contacts received in the contact grooves and a switch supported by the insulative housing. The switch include a first switch pin and a second switch pin. The first switch pin has a first contacting portion and a reacting portion extending from the first contacting portion. The second switch portion has a second contacting portion. A slider is mounted adjacent to the switch contacts. The slider is configured a recess and a depressing portion. When the reacting portion is located in the recess, the first contacting portion separating from the second contacting portion. And when the depressing portion depresses the reacting portion, the first contacting portion is in contacting with the second contacting portion.

The detailed features of the present invention will be apparent in the detailed description with appropriate reference to the accompanying drawings.

### BRIEF DESCRIPTION OF THE DRAWINGS

FIG. 1 is a perspective view of an electrical card connector of a first embodiment in accordance with the present invention;

FIG. 2 is a partially exploded, perspective view of the electrical card connector;

FIG. 3 is an exploded, perspective view of the electrical card connector;

FIG. 4 is a perspective view of two switch contacts and a slider of the electrical card connector;

FIG. 5 is a perspective view of a slider of the electrical card connector;

FIG. 6 is similar to FIG. 2, but a card inserted into the electrical card connector;

FIG. 7 is a cross-section view of FIG. 6 taken along line 7-7, but the card is not inserted into the electrical card connector;

FIG. 8 is similar to FIG. 7, but the card inserted into the electrical card connector;

FIG. 9 is a partially exploded, perspective view of a second embodiment of the card electrical connector;

FIG. 10 is a partially exploded, perspective view of the electrical card connector shown in FIG. 9;

FIG. 11 is a perspective view of a slider of the electrical card connector shown in FIG. 9;

FIG. 12 is a cross-section view of FIG. 9 taken along line 12-12, but a shell is mounted on a housing; and

FIG. 13 is perspective view of the electrical card connector shown in

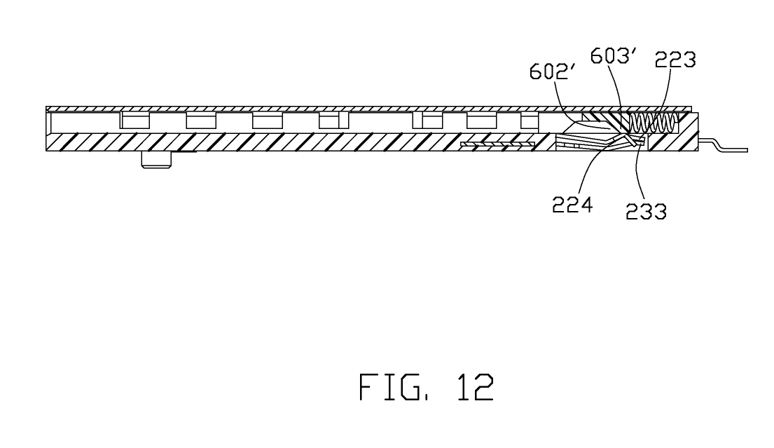

FIG. 12, but the card inserted therein.

### DETAILED DESCRIPTION OF THE INVENTION

Reference will now be made in detail to the preferred embodiment of the present invention.

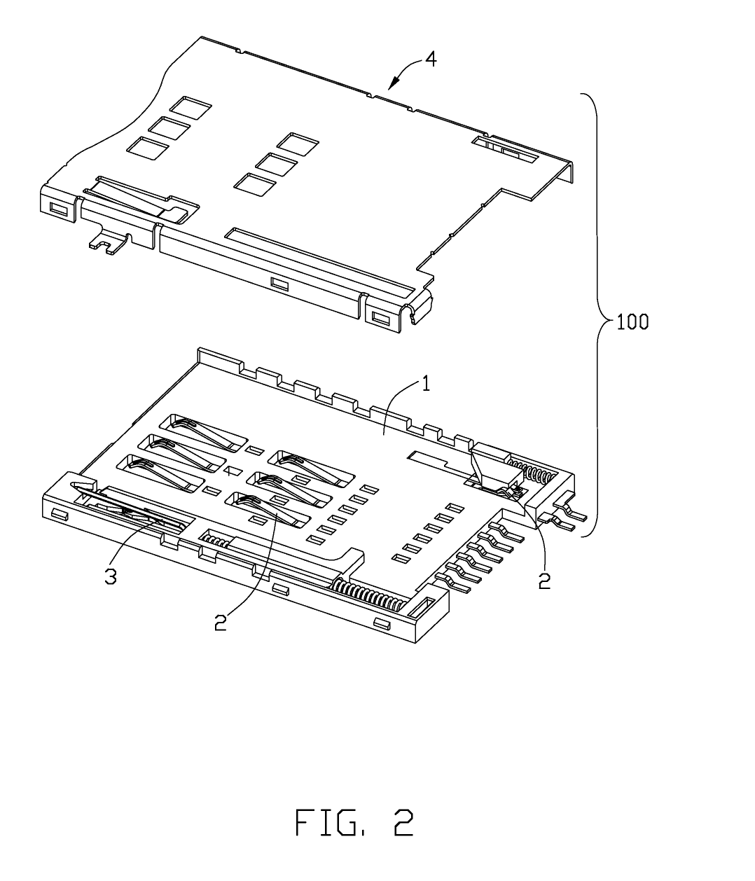

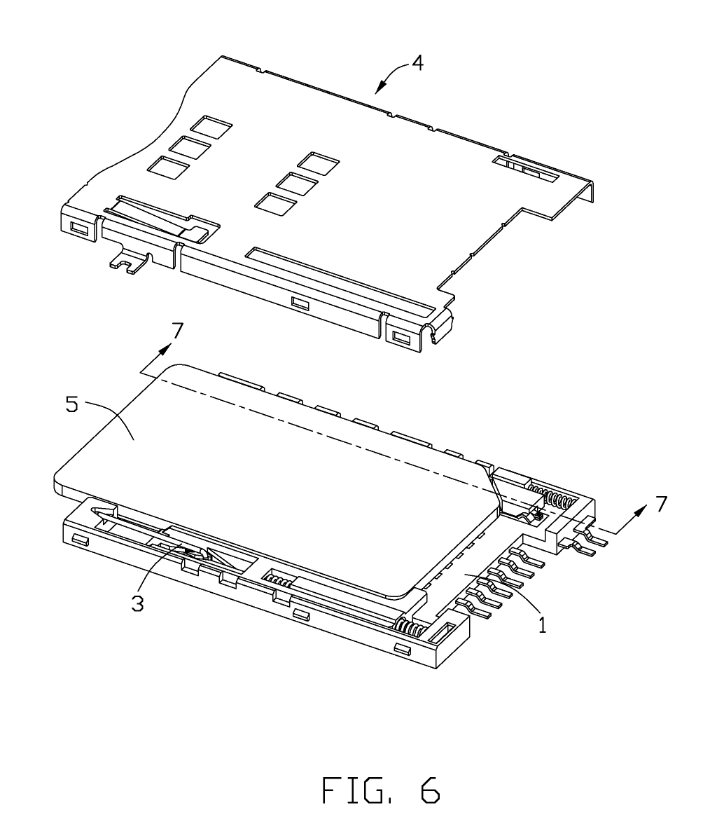

Reference will now be made to the drawing figures to describe a preferred embodiment of the present invention in detail. Referring to FIGS. 2 and 6, an electrical card connector 100 in accordance with the present invention is configured to receive a card 5 therein. The electrical card connector 100 comprises an insulative housing 1, a plurality of contacts 2 mounted to the insulative housing 1, an ejector 3 slidably to the insulative housing 1 and a metallic shell 4 enclosing the insulative housing 1.

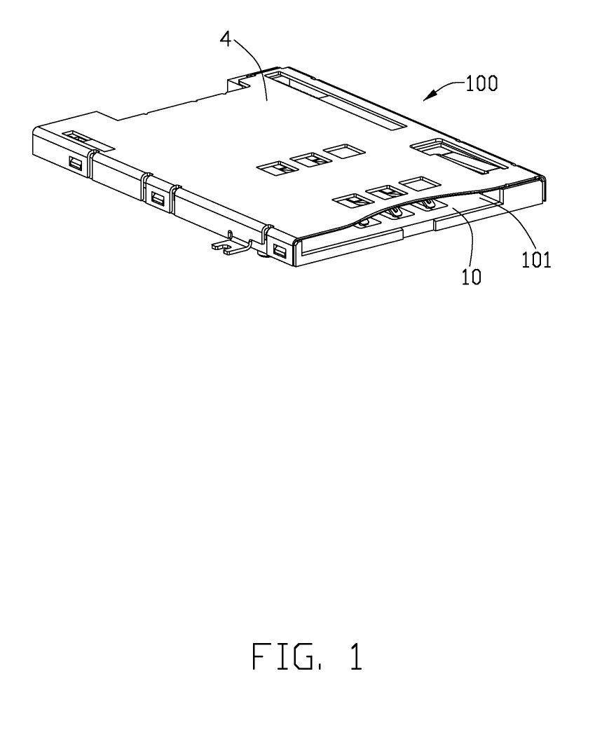

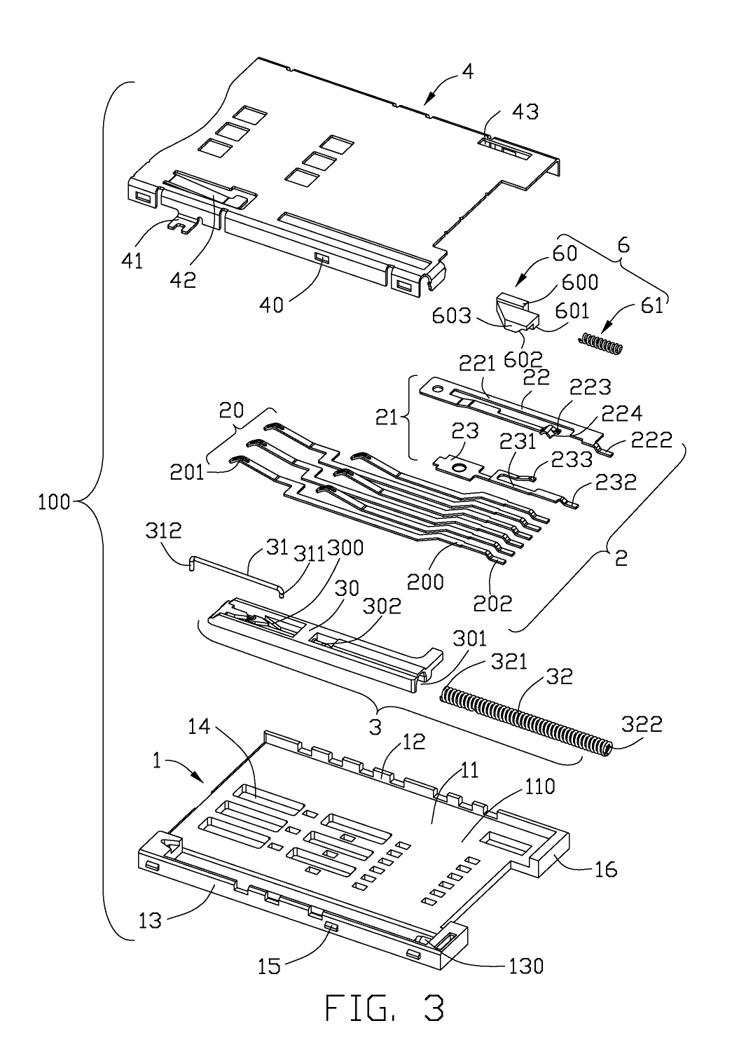

Referring to FIGS. 1 and 3, the insulative housing 1 includes a base portion 11, a first lateral wall 12 and a second lateral wall 13 opposite to the first lateral wall 12. A plurality of contact grooves 14 are defined in the middle of the base portion 11 and arranged in two neighboring rows. In addition, the insulative housing 1 has a receiving space 10 for communicating with the contact grooves 14.

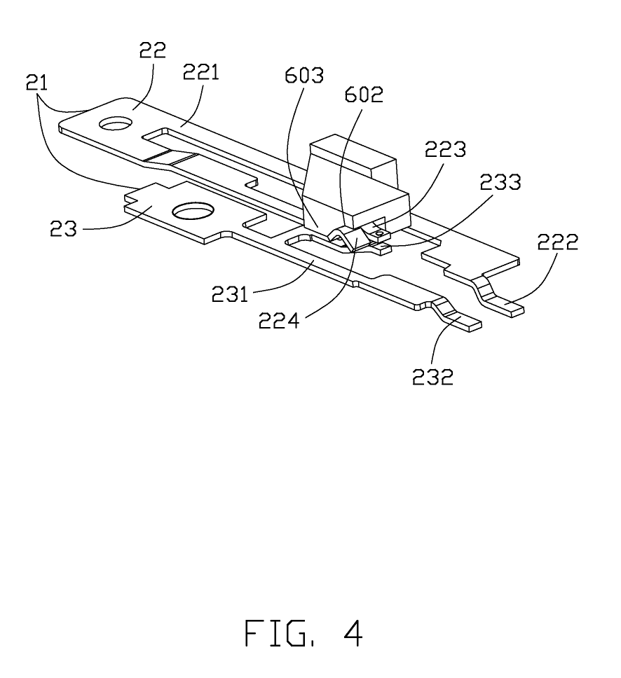

Referring to FIGS. 3 and 4, the contacts 2 are molded in the insulative housing 1. The contacts 2 include a plurality of signal contacts 20 and a switch 21 which includes a first switch pin or deflectable contact 22 and a second switch pin or responding contact 23. The first switch pin 22 includes a first retaining portion 221 combined with the insulative housing 1, a first soldering portion 222 and a first contacting portion 223 bending from opposite ends of the first retention portion 221. The second switch pin 23 includes a second retaining portion 231 combined with the insulative housing 1, a second soldering portion 232 and a second contacting portion 233 bending from the opposite end of the second retention portion 231. When the switch 21 is assembled to the insulative housing 1, the first and second soldering portions 223, 233 are arranged abreast, and the first and second contacting portion 223, 233 are located correspondingly with each other along a top-down direction perpendicular to the base portion 11. The signal contacts 20 received into the insulative housing 1 includes a fixed portion 200, a touching portion 201 and a tail portion 202 bending from opposite two ends of the fixed portion 200, with the meeting portion 201 extending into the receiving space 10. The touching portions 201 are arranged in two rows for mechanically and electrically contacting with the card 5, and the tail portions 202 are arranged in a single row. The first switch pin 22 defines a reacting portion 224 extending from the first contacting portion 223.

Referring to FIG. 3, the ejector 3 includes a sliding member 30, a follower 31 and a spring member 32. The sliding member 30 has a heart-shaped groove 300 and a recess 301 located at end thereof. The follower 31 has a first end 311 located in the heart-shaped groove 300, and a second end 312 secured into the insulative housing 1. There is a first positioning post 302 located in the recess 301 adjacent to the heart-shaped groove 300 and a second positioning post 130 protruding from a rear of the second side wall 13 corresponding to the first positioning post 302. The spring member 32 has a first end 321 interlinked to the first positioning post 302, and a second end 321 assembled to the second to the second positioning post 130.

Referring to FIGS. 2 and 3, the metallic shell 4 has a plurality of locking holes 40 located at two sides thereof for respectively locking with a plurality of tubers 15 located on the first and second side wall 12,13 to have the metallic shell 4 and the insulative housing 1 retained each other. The metallic shell 4 also defines a soldering pad 41 at each side thereof respectively for soldering onto a printed circuit board (not shown), and a spring piece 42 corresponding to and pressing the follower 31 for preventing the follower 31 from moving upwardly during operation.

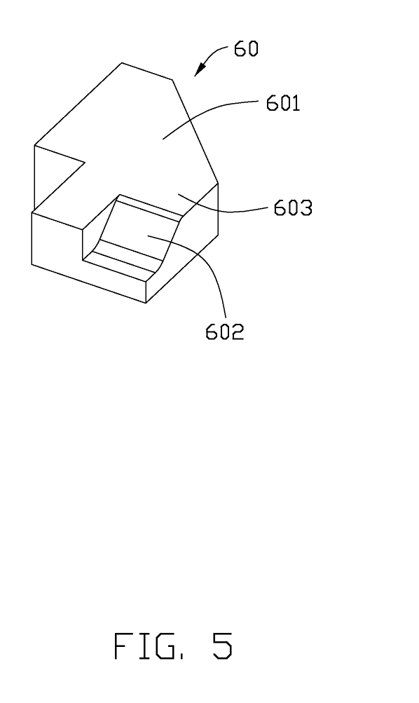

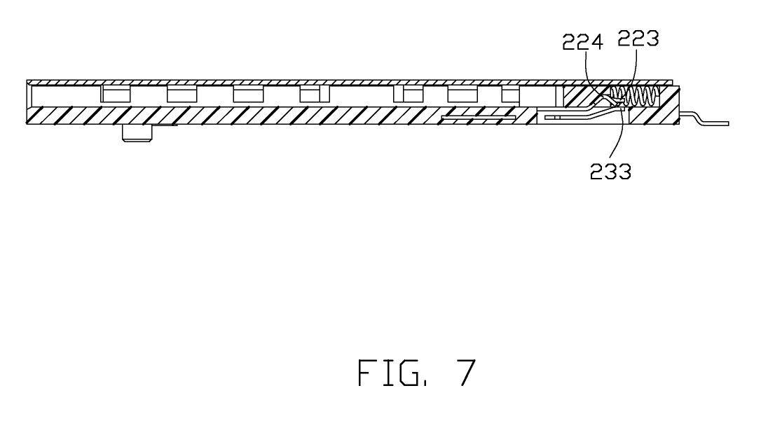

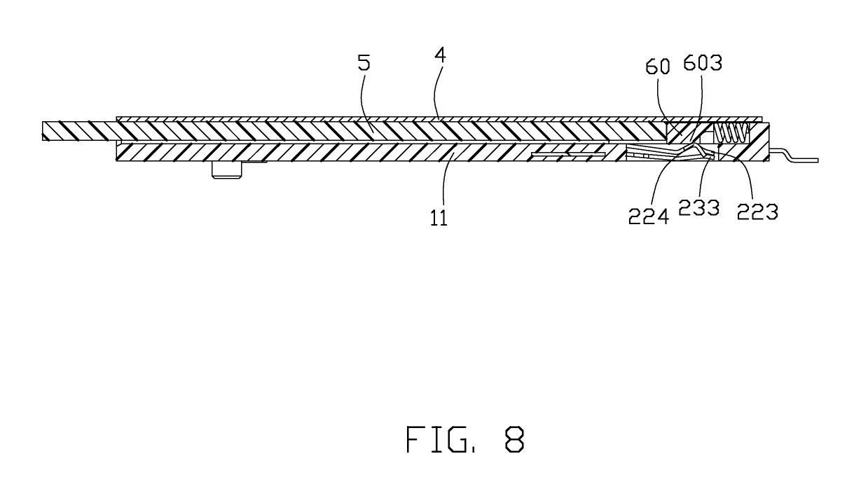

Referring to FIGS. 1-8, the electrical card connector 100 further includes a sliding device 6 located adjacent to the switch 21. The sliding device 6 can also be referred to as an inserted-card positioning detecting device. The sliding device 6 has a slider 61 and a spring 62 located between the slider 61 and the insulative housing 1. The slider 61 has a limiting portion 600 extending from the top side of the slider 61 to the metallic shell 4. The metallic shell 4 sets a cutout 43 defined in a front segment and located to adjacent a front end surface 16 of the insulative housing 1. The limiting portion 600 is enclosed in the cutout 43 to slide along a direction of which the card is inserted in/pulled out of the receiving space 10. The insulative housing 1 has a top surface 110 in the receiving space 10, and the slider 60 has a bottom surface 601 opposite to the top surface 110. The slider 60 defines a recess 602 sinking from the bottom surface 601 and communicating with the receiving space 10 and a depressing portion 603 adjacent with the recess 602. The recess 602 is used for receiving the reacting portion 224, and a depressing portion 603 which is used for holding the reacting portion 224 downwards. The electrical card connector 100 has an inserting opening 101 for allowing the card 5 to be inserted therein, and the recess 602 is closer to the inserting opening 101 than the depressing portion 603. When the card 5 is not inserted into the receiving space 10, the reacting portion 224 is received into the recess 602, and the first contacting portion 223 of the first switch pin 22 separates from the second contacting portion 233 of the second switch pin 23. And when the card 5 is inserted into the receiving space 10, the front end of the card 5 will drive the slider 60 to move forward to the front end surface 16, resulting in the depressing portion 603 to press the reacting portion 224 moving downwardly and brings the first contacting portion 223 moving downwardly too to contact the second contacting portion 233, so as to determine whether the card 5 is located at a proper position in the receiving space 10. And when the slider 60 is resumed to its original position by the spring 62 while the card 5 is pulled out, the first contacting portion 223 of the first switch pin 22 separates from the second contacting portion 233 of the second switch pin 23 again showing there is no card inserted therein. On the other hand, if the slider is not driven to the final portion, the first contacting portion 223 of the switch pin 22 will also separate from the second contacting portion 233 of the second switch 23 indicating an improper or incorrect insertion of the card. Of course, in other embodiments, the second contacting portion also could form on a printed circuit board to be contacted by the first contacting portion for detecting the card 5.

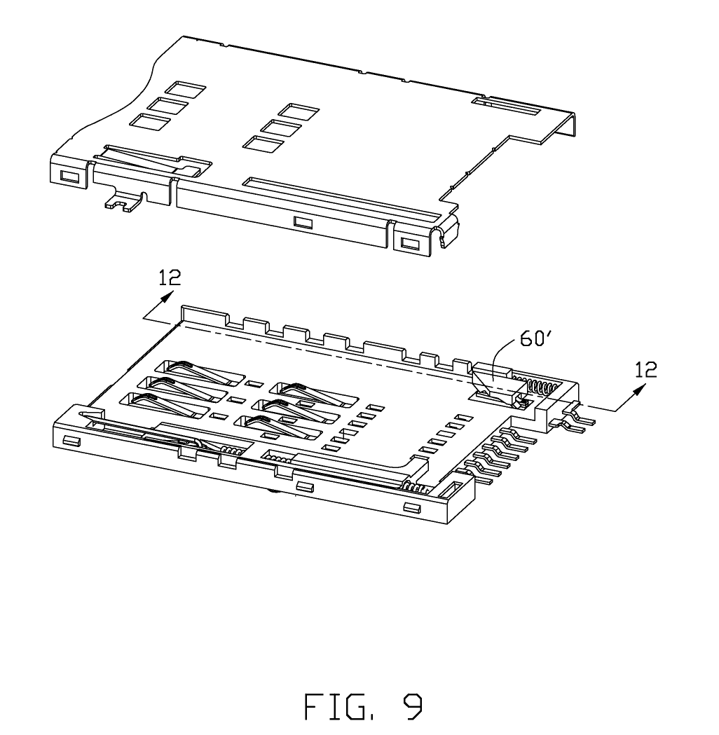

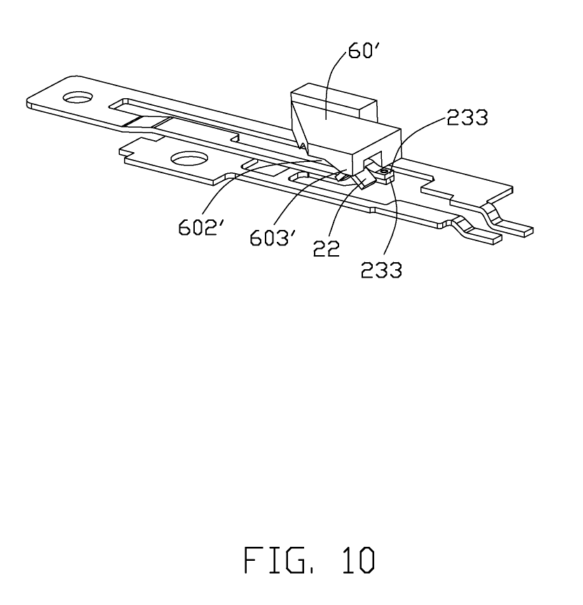

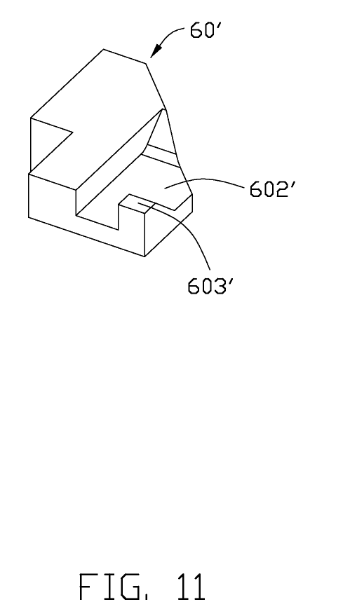

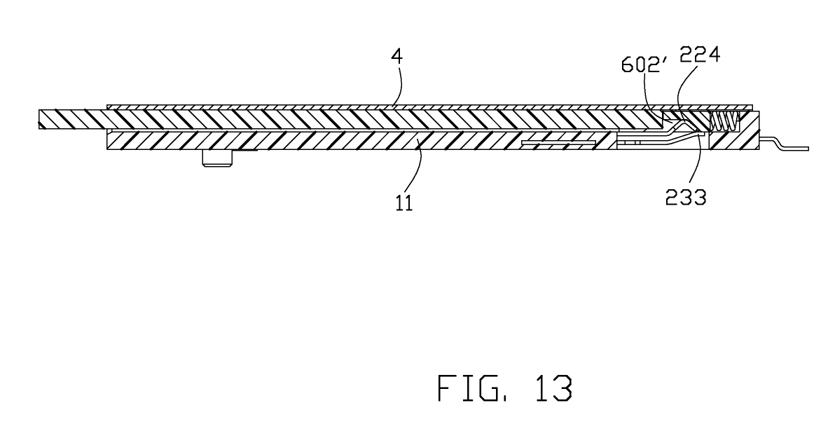

FIGS. 9-13 show a second embodiment of the card edge connector assembly. For simplicity, the same reference numeral used in the second embodiment represents the same elements such as disclosed in the first embodiment. The mainly different, the second embodiment has a slider device 6′. The slider device 6′ defines a recess 602′ for receiving a first contacting portion 223 and a depressing portion 603′ for pressing the reacting portion 224 of the first switch pin 22. Before the card 5 is inserted into the receiving space 10, the depressing portion 603′ presses the reacting portion 224, with the first contacting portion 223 contacting the second contacting portion 233. And when the card 5 is inserted into the receiving space 10, the front end of the card 5 will drive the slider 60′ sliding forward to the front end surface 16, then the reacting portion 224 goes into the recess 602′. Resulting in the first contacting portion 223 is moved upwardly and separated from the second contacting portion 233 indicating the inserted card is positioned in the predetermined. In this way, the card 5 is ensured in the correct position.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical card connector, comprising:
an insulative housing having a plurality of contact grooves;
a plurality of signal contacts received in the contact grooves, a switch supported by the insulative housing and including a first switch pin and a second switch pin, and the first switch pin having a first contacting portion and a reacting portion extending from the first contacting portion, the second switch portion having a second contacting portion; and
a slider is mounted adjacent to the switch contacts, the slider is configured with a recess and a depressing portion, and wherein when the reacting portion is located in the recess, the first contacting portion separating from the second contacting portion, and when the depressing portion depresses the reacting portion, the first contacting portion is in contacting with the second contacting portion of the second switch pin.

2. The electrical card connector as claimed in claim 1, further comprising a inserting opening, with the recess being closer to the inserting opening than the depressing portion.

3. The electrical card connector as claimed in claim 1, further comprising a inserting opening, with the depressing portion being closer to the inserting opening than the recess.

4. The electrical card connector as claimed in claim 2, wherein the switch comprises a first switch pin and a second switch pin;
the first switch pin comprising a first retention portion, a first soldering portion bending from one end of the first retention portion which the first contacting portion bending from the other end thereof, and a reacting portion extending from the first contacting portion and pressed by the slider;
the second switch pin comprising a second retention portion, a second soldering portion bending from one end of the second retention portion which the second contacting portion bending the other end thereof; and
the first and the second soldering portion arrange a single row.

5. The electrical card connector as claimed in claim 4, wherein the insulative housing defines a base portion, with the first and the second contacting portions locating correspondingly with each other along a top-down direction perpendicular to the base portion.

6. The electrical card connector as claimed in claim 5, further comprising an ejector having a sliding member, a follower mounting on the sliding member and a spring member receiving into the sliding member.

7. The electrical card connector as claimed in claim 6, wherein the insulative housing defines a receiving space for communicating with the contact grooves.

8. The electrical card connector as claimed in claim 7, wherein the contacts further comprise a plurality of signal contacts molded in the insulative housing, the signal contact has a fixed portion, a touching portion and a tail portion bending from opposite two ends of the fixed portion, with the touching portion extending into the receiving space.

9. The electrical card connector as claimed in claim 8, wherein the touching portions are arranged two rows for mechanically and electrically contacting with a card and the tail portions are arranged one row.

10. The electrical card connector as claimed in claim 9, further comprising a metallic shell enclosing the insulative housing, and the metallic shell defines a soldering pad at two sides thereof respectively for soldering to a printed circuit board.

11. An electrical card connector having a position detecting mechanism, comprising:
a metallic shell defining a receiving space and with a connector arranged in a rear portion thereof;
an inserted-card positioning detecting device arranged within the metallic shell, and including a slider having a depressing portion and a switching configured by a deflectable contact and responding contact; and
wherein when the slider is moved to a first position when a card is correctly inserted, the depressing portion will press the deflectable contact in contact with the responding contact; and when the inserted card is removed therefrom, the deflectable contact will be separated from the responding contact when the depressing portion is moved away from the depressing portion.

12. The electrical card connector as claimed in claim 11, wherein the slider comprising a recess for receiving a reacting portion of the deflectable contact and the depressing portion for pressing the reacting portion, with the recess and the depressing portion locating along a direction the slider sliding.

13. The electrical card connector as claimed in claim 11, wherein the card inserts into the receiving space along a rear-to-front direction, and the device locates in a front segment of the receiving space, with a spring of the device positioning between the slider and the insulative housing.

14. An electrical card connector for use with an electronic card, comprising:
an insulative housing defining a card receiving space in communication with an exterior in a front-to-back direction;
a slider receiving space located beside the card receiving space in a transverse direction perpendicular to said front-to-back direction;
a plurality of contacts disposed in the housing with contacting sections extending into the card receiving space in a vertical direction perpendicular to both said front-to-back direction and said transverse direction;
a switch disposed in the housing with first and second switch pins facing toward the slider receiving space, said first switch pin being moveable and including a first contacting portion associated with a reacting portion, and the second switch pin including a second contacting portion aligned with the first contacting portion;
a slider received in the slider receiving space and back and forth moveable along the front-to-back direction essentially between opposite front and rear positions in response to back and forth movement of the electronic card and by means of a spring, said slider defining a depressing portion and a recess aligned with not only each other but also the reacting portion in the front-to-back direction; and
another slider mounted to the housing beside the card receiving space and moveable in the front-to-back direction for engagement with the electronic card to decide front and rear locations of the electronic card within the card receiving space; wherein
when the depressing portion contacts the reacting portion, the first contacting portion contacts the second contacting portion to have the first switch pin and the second switch pin mechanically and electrically connected to each other; when the depressing portion leaves the reacting portion and the reacting portion is received in the recess, the first contacting portion does not contact the second contacting portion to have the first switch pin and the second switch pin mechanically and electrically disconnected from each other.

15. The electrical card connector as claimed in claim 14, wherein the first switch pin is moveable in the vertical direction.

16. The electrical card connector as claimed in claim 15, wherein said first contacting portion and the reacting portion are arranged off set from each other in the transverse direction.

17. The electrical card connector as claimed in claim 15, wherein said second contacting portion is located under the first contacting portion in the vertical direction.

18. The electrical card connector as claimed in claim 14, wherein the slider and the another side are respectively by two sides of the card receiving space, respectively, for balancing movement of the electronic card in the card receiving space.

19. The electrical card connector as claimed in claim 18, further including a metallic shell covering the housing and the slider and the another slider in the vertical direction.

20. The electrical card connector as claimed in claim 19, wherein the shell defines two slots to receive corresponding ribs formed on the slider and the another slider, respectively, for guiding back and forth movement of the slider and the another slider in the front-to-back direction.
